(19) United States
(12) Patent Application Publication
(10) Pub. No.: US 2026/0264610 A1
(43) Pub. Date: Sep. 10, 2026

(54) EXTERIOR MIRROR ASSEMBLY WITH ACTUATOR

(71) Applicant: Chris Cam Industry Inc., Tainan City (TW)

(72) Inventors: Hung-Lung Chen, Tainan City (TW); Wen-Sen Wu, Tainan City (TW); Kai-I Teng, Tainan City (TW)

(73) Assignee: Chris Cam Industry Inc., Tainan City (TW)

(21) Appl. No.: 19/664,239

(22) Filed: Apr. 30, 2026

Related U.S. Application Data
(63) Continuation-in-part of application No. 18/469,872, filed on Sep. 19, 2023, now Pat. No. 12,637,006.

(51) Int. Cl. B60R 1/072; B60R 1/074

(52) U.S. Cl. CPC B60R 1/072; B60R 1/074

(57) ABSTRACT

An exterior mirror assembly with an actuator is provided. The actuator comprises: a gear element, a driving unit and a limiting element. The driving unit is configured to impart a rotation of the gear element. The limiting element is adjacent to a circumference of the gear element. The gear element has a teeth portion with a first end and a second end and the teeth portion extends along the circumference of the gear element. The limiting element leans against the first end or the second end of the teeth portion when the driving unit drives the gear element to rotate by an angle.

### 1. CROSS-REFERENCE TO RELATED APPLICATIONS

This application is a continuation-in-part of U.S. patent application Ser. No. 18/469,872, filed Sep. 19, 2023, which is hereby incorporated by reference for purposes as if fully set forth herein.

### BACKGROUND

### 2. Field of the Disclosure

The instant disclosure relates to exterior rearview mirror assemblies and, more particularly, to an exterior rearview mirror assembly that is adjustable relative to the side of the vehicle to which it is mounted.

### 2. Description of Related Art

It is known to provide a vehicular exterior rearview mirror assembly that has a mirror head having a mirror casing that is adjustable relative to a mirror mounting portion at the side of the vehicle to which the mirror assembly is mounted. The mirror assembly may comprise a power-fold assembly where the mirror head is adjusted or pivoted relative to the vehicle via an actuator disposed at the mirror mounting portion and/or mirror head.

The common actuator is designed to use a disc in combination with positioning pins and springs to position the mirror head relative to the side of the vehicle. However, the disc and the positioning pins are vertically arranged with each other, and the bottom of the disc should have inclined sliding grooves that can be matched with the positioning pins. As a result, this configuration will increase the overall weight and thickness of the actuator.

### SUMMARY

According to one example embodiment of the instant disclosure, an exterior rearview mirror assembly for a vehicle comprises a mounting portion mountable at a side of a vehicle, a mirror head portion adjustably mounted at said mounting portion; a reflective element at said mirror head portion; and an actuator operable to impart pivotal movement of said mirror head portion relative to said mounting portion. Further, the actuator comprises: a gear element, a driving unit and a limiting element. The gear element has a teeth portion and a missing teeth region. The driving unit is configured to drive the gear element to pivot the mirror head portion relative to the mounting portion. The limiting element is located to corresponding to the missing teeth region and configured to contact an end of the teeth portion when the mirror head portion pivots relative to the mounting portion at an angle.

According to another example embodiment of the instant disclosure, an actuator for an exterior rearview mirror assembly for a vehicle, comprises: a gear element, a driving unit and a limiting element. The driving unit is configured to impart a rotation of the gear element. The limiting element is adjacent to a circumference of the gear element. The gear element has a teeth portion with a first end and a second end and the teeth portion extends along the circumference of the gear element. The limiting element leans against the first end or the second end of the teeth portion when the driving unit drives the gear element to rotate by an angle.

According to another example embodiment of the instant disclosure, an actuator for an exterior rearview mirror assembly for a vehicle, comprises: a housing, a partly tooth missing gear element, a driving unit and a limiting element. The partly tooth missing gear element is received in the housing. The driving unit is configured to drive the partly tooth missing gear element to rotate. The limiting element is fixed to the housing and configured to prevent from the partly tooth missing gear element from rotating when the limiting element engages with the partly tooth missing gear.

In order to further understanding of the instant disclosure, the following embodiments are provided along with illustrations to facilitate appreciation of the instant disclosure; however, the appended drawings are merely provided for reference and illustration, and do not limit the scope of the instant disclosure.

### BRIEF DESCRIPTION OF THE DRAWINGS

FIG. 1 is a schematic rear view of an exterior rearview mirror assembly in accordance with an embodiment of the instant disclosure.

FIG. 2 is an exploded perspective view of an actuator of an exterior rearview mirror assembly in accordance with an embodiment of the instant disclosure.

FIG. 3 is a perspective view of an actuator of an exterior rearview mirror assembly in accordance with an embodiment of the instant disclosure.

FIG. 4A shows an actuator of an exterior rearview mirror assembly in accordance with an embodiment of the instant disclosure, wherein the actuating gear element rotates in a clockwise direction.

FIG. 4B shows an actuator of an exterior rearview mirror assembly in accordance with an embodiment of the instant disclosure, wherein a limiting element engages/contacts an actuating gear element.

FIG. 5A shows an exterior rearview mirror assembly in accordance with an embodiment of the instant disclosure, wherein a mirror head portion rotates toward a folded position.

FIG. 5B shows an exterior rearview mirror assembly in accordance with an embodiment of the instant disclosure, wherein a mirror head portion is positioned at a predetermined minimum angle relative to a side of a vehicle.

FIG. 6A shows an actuator of an exterior rearview mirror assembly in accordance with an embodiment of the instant disclosure, wherein the actuating gear element rotates in a counter-clockwise direction.

FIG. 6B shows an actuator of an exterior rearview mirror assembly in accordance with an embodiment of the instant disclosure, wherein a limiting element engages/contacts an actuating gear element.

FIG. 7A shows an exterior rearview mirror assembly in accordance with an embodiment of the instant disclosure, wherein a mirror head portion rotates toward a use position.

FIG. 7B shows an exterior rearview mirror assembly in accordance with an embodiment of the instant disclosure, wherein a mirror head portion is positioned at a predetermined maximum angle relative to a side of a vehicle.

FIG. 8 is a block diagram of an actuator connected to a power-off circuit.

FIG. 9 shows various embodiments of a limiting element of an actuator.

FIG. 10 shows a perspective view of an actuator of an exterior rearview mirror assembly in accordance with an embodiment of the instant disclosure.

FIG. 11 is a schematic rear view of an exterior rearview mirror assembly in accordance with an embodiment of the instant disclosure.

FIG. 12 is an exploded perspective view of an actuator of an exterior rearview mirror assembly in accordance with an embodiment of the instant disclosure.

FIG. 13 is a perspective view of an actuator of an exterior rearview mirror assembly in accordance with an embodiment of the instant disclosure.

FIG. 14A shows an actuator of an exterior rearview mirror assembly in accordance with an embodiment of the instant disclosure, wherein the actuating gear element rotates in a clockwise direction.

FIG. 14B shows an actuator of an exterior rearview mirror assembly in accordance with an embodiment of the instant disclosure, wherein a limiting element engages/contacts an actuating gear element.

FIG. 15A shows an exterior rearview mirror assembly in accordance with an embodiment of the instant disclosure, wherein a mirror head portion rotates toward a folded position.

FIG. 15B shows an exterior rearview mirror assembly in accordance with an embodiment of the instant disclosure, wherein a mirror head portion is positioned at a predetermined minimum angle relative to a side of a vehicle.

FIG. 16A shows an actuator of an exterior rearview mirror assembly in accordance with an embodiment of the instant disclosure, wherein the actuating gear element rotates in a counter-clockwise direction.

FIG. 16B shows an actuator of an exterior rearview mirror assembly in accordance with an embodiment of the instant disclosure, wherein a limiting element engages/contacts an actuating gear element.

FIG. 17A shows an exterior rearview mirror assembly in accordance with an embodiment of the instant disclosure, wherein a mirror head portion rotates toward a use position.

FIG. 17B shows an exterior rearview mirror assembly in accordance with an embodiment of the instant disclosure, wherein a mirror head portion is positioned at a predetermined maximum angle relative to a side of a vehicle.

FIG. 18 is a block diagram of an actuator connected to a power-off circuit.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

This description of illustrative embodiments is intended to be read in connection with the accompanying drawings, which are to be considered part of the entire written description. In the description of embodiments disclosed herein, any reference to direction or orientation is merely intended for convenience of description and is not intended in any way to limit the scope of the present disclosure. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected” and “interconnected,” refer to a relationship wherein structures are secured or attached to one another either directly or indirectly through intervening structures, as well as both movable or rigid attachments or relationships, unless expressly described otherwise. Moreover, the features and benefits of the disclosure are illustrated by reference to the embodiments. Accordingly, the disclosure expressly should not be limited to such embodiments illustrating some possible non-limiting combination of features that may exist alone or in other combinations of features; the scope of the disclosure being defined by the claims appended hereto.

Present disclosure provides an actuator for an exterior rearview mirror assembly for a vehicle. The actuator may be equipped with a limiting element configured to align an actuating gear element. The actuating gear element may be connected to a mirror head and may be responsible for driving its rotation. When the limiting element engages with the actuating gear element, the actuating gear element stops rotating and the mirror head also stops rotating accordingly.

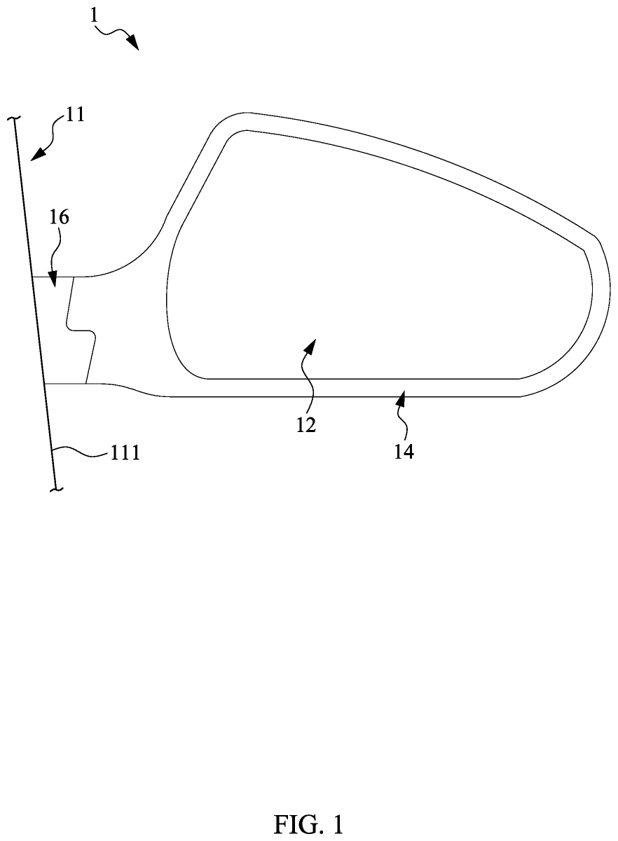

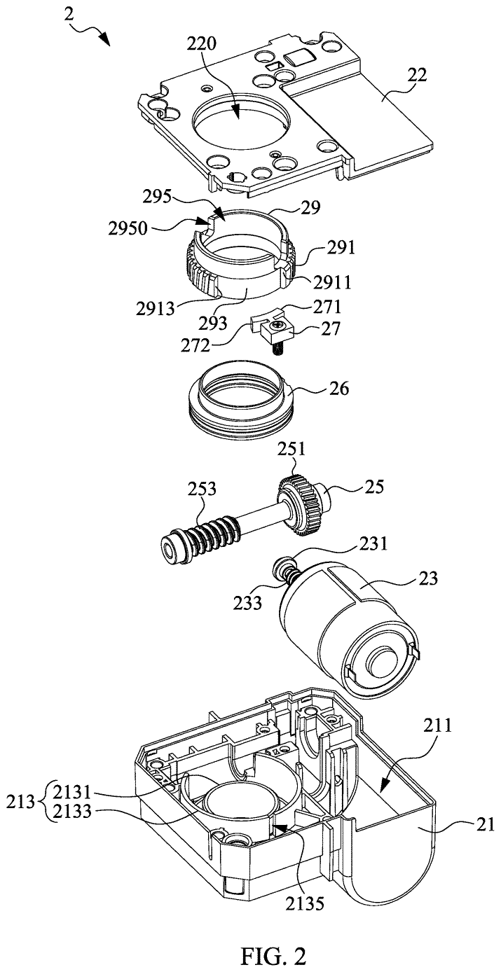

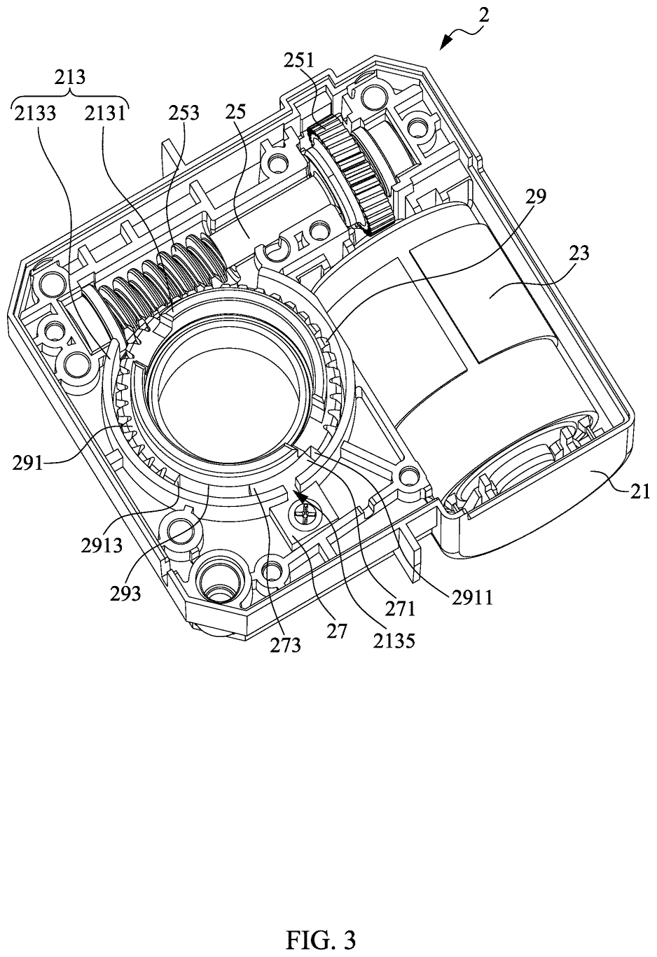

FIG. 1 is a schematic rear view of an exterior rearview mirror assembly 1 for a vehicle 11 in accordance with an embodiment of the instant disclosure. As shown in FIG. 1, the exterior rearview mirror assembly 1 for the vehicle 11 may include a mirror reflective element 12, a mirror head portion 14, a mounting portion 16 and an actuator 2 (FIGS. 2 and 3). The mirror reflective element 12 may be received in and/or supported by the mirror head portion. The mirror head portion 14 may be movably mounted to a mounting portion 16 via the actuator 2.

The mounting portion 16 may be mounted at a side 111 of the vehicle 11, and the mirror reflective element 12 may provide a rearward field of view along the respective side of the vehicle 11 to the driver of the vehicle 11. The actuator 2 may be received or disposed at least partially in mounting portion 16 (and/or at or at least partially in a side portion of the vehicle 11 and/or at or at least partially in the mirror head portion 14 of the exterior rearview mirror assembly 1) and is operable to pivot the mirror head portion 14 relative to the mounting portion 16 to adjust the mirror head portion 14 between a rearward viewing position or orientation, where the mirror head portion 14 and mirror reflective element 12 are positioned so as to provide a rearward field of view to the driver of the vehicle 11, and a folded or stowed position, where the mirror head portion 14 and mirror reflective element 12 are oriented generally along the side 111 of the vehicle 11.

The mounting portion 16 may be fixed to the side 111 of the vehicle and the mirror head portion 14 may be pivotally or adjustably disposed at an outer of the mounting portion 16. The mounting portion 16 may comprise a generally hollow portion or cavity for receiving the actuator 2 therein, and the mirror head portion 14 may be connected to the actuator 2 directly or indirectly.

In some embodiments of the present disclosure, the mirror reflective element 12 may be attached to a mounting surface of or at the mirror head portion 14. In some embodiments of the present disclosure, the mirror reflective element 12 may be received in or partially received in a receiving structure or bezel structure at the mirror head portion 14 (and may be attached at a mounting plate or backing plate that may be adjustably mounted or disposed in the mirror casing and that may be adjustable via a powered mirror reflective element adjustment actuator to allow for adjustment of the mirror reflective element 12 relative to the mirror casing to establish a desired rearward field of view to the driver of the vehicle), while remaining within the spirit and scope of the present invention. The mirror reflective element 12 may be adjustably mounted or supported at or in or partially in the mirror head portion 14, such as via a reflective element actuator or the like.

FIG. 2 is an exploded perspective view of the actuator 2 of the exterior rearview mirror assembly 1 in accordance with an embodiment of the instant disclosure. FIG. 3 is a top plan view of the actuator 2 of the exterior rearview mirror assembly 1 in accordance with an embodiment of the instant disclosure. The actuator 2 may be operable to pivot or adjust the mirror head portion 14 relative to the mounting portion 16 such that the mirror head portion 14 may be adjusted relative to mounting portion 16 about a generally vertical pivot axis. As shown in FIGS. 2 and 3, the actuator 2 may include a housing portion 21, a cover portion 22, a driving unit 23, a driving shaft 25, a bearing assembly 26, a limiting element 27 and an actuating gear element 29. The housing portion 21 and the cover portion 22 may be matched with each other and together form an outer casing of the actuator 2. The outer casing formed by the housing portion 21 and the cover portion 22 may be at least partially received in the mounting portion 16 and configured to house or support the driving unit 23, the driving shaft 25, the bearing assembly 26, the limiting element 27 and the actuating gear element 29. In some embodiments of the present disclosure, the housing portion 21 and the cover portion 22 may be configured or molded to provide an inner cavity for receiving the driving unit 23, the driving shaft 25, the bearing assembly 26, the limiting element 27 and the actuating gear element 29.

Referring to FIGS. 2 and 3, the housing portion 21 may include an inner space 211 for receiving the driving unit 23. In some embodiments of the present disclosure, the driving unit 23 may include a rotary motor. In some embodiments of the present disclosure, the driving unit 23 may consist of electrically powered motors, which can be connected to the vehicle's power source. This connection can be achieved through electrical leads of the motor that are connected to the vehicle wiring harness located at the side of the vehicle and at the mounting portion 16.

The driving unit 23 may include a rotationally driven output shaft 231 with a worm gear 233 attached to the output shaft 231. The driving shaft 25 may include a gear 251 and a worm gear 253. The gear 251 may be disposed to be adjacent to one end of the driving shaft 25 and the worm gear 253 may be disposed to be adjacent to an opposite end of the driving shaft 25. The teeth of the worm gear 233 of the driving unit 23 may engage the teeth of the gear 251 of the driving shaft 25. Once the driving unit 23 drives the worm gear 233 to rotate, it will cause the driving shaft 25 with the gear 251 meshing with the worm gear 233 to rotate. Further, the worm gear 253 attached to the opposite end of the driving shaft 25 may rotate accordingly.

Referring to FIG. 2, the housing portion 21 may include an axle portion 213, and the axle portion may include an inner wall 2131 and an outer wall 2133 which substantially surrounds the inner wall 2131. As shown in FIG. 2, the inner wall 2131 and the outer wall 2133 are spaced apart from each other, and thus a groove is formed between the inner wall 2131 and the outer wall 2133. The bearing assembly 26 and the actuating gear element 29 may be received in the groove formed between the inner wall 2131 and the outer wall 2133. That is, the actuating gear element 29 may be fitted onto the axle portion 213 of the housing portion 21 and rotatably supported (such as via the bearing assembly 26) at the housing portion 21.

In some embodiments of the present disclosure, the actuating gear element 29 may include a ring-shaped gear. In some embodiments of the present disclosure, the actuating gear element 29 may include a worm wheel. In some embodiments of the present disclosure, the actuating gear element 29 may include a partly tooth missing gear. That is, the actuating gear element 29 may include a teeth portion 291 and a missing teeth region 293. The teeth portion 291 may extend along a circumference of the actuating gear element 29 and include two end portions 2911 and 2913. The missing teeth region 293 may also extend along a circumference of the actuating gear element 29 and be located between the two end portions 2911 and 2913 of the teeth portion 291. Further, the teeth of the teeth portion 291 may engage the teeth of the worm gear 253 of the driving shaft 25. Thus, when the driving unit 23 drives the driving shaft 25 to rotate, the worm gear 253 of the driving shaft 25 may cause the actuating gear element 29 to rotate accordingly.

Moreover, the actuating gear element 29 may include an attaching portion 295 with a slot 2950. In some embodiments of the present disclosure, the mirror head portion 14 may be connected to the actuating gear element 29 through the attaching portion 295 and/or the slot 2950 of the attaching portion 295. In some embodiments of the present disclosure, the mirror head portion 14 may be connected to the actuating gear element 29 via an attaching means, and the attaching means may be fixedly attached at the attaching portion 295 and/or the slot 2950 of the attaching portion 295. That is, the rotation of the actuating gear element 29 may impart a corresponding rotation of mirror head portion 14 about the generally vertical axis of rotation and relative to the side 111 of the vehicle 11 equipped with the exterior rearview mirror assembly 1.

Referring to FIGS. 2 and 3, the limiting element 27 may be fixed to the housing portion 21 and adjacent to the actuating gear element 29. In some embodiments of the present disclosure, the limiting element 27 may be fixed to the housing portion 21 by a screw. The limiting element 27 may be disposed at the outer wall 2133 of the axle portion 213. In some embodiments of the present disclosure, the limiting element 27 may be received in a gap 2135 of the outer wall 2133 of the axle portion 213. As shown in FIG. 3, the limiting element 27 may be located to abut the circumference of the actuating gear element 29 and substantially align or correspond to the missing teeth region 293 of the actuating gear element 29. Further, the limiting element 27 may have wing portions 271 and 273. The wing portions 271, 273 may abut the missing teeth region 293 of the actuating gear element 29 and substantially extend along the circumference of the actuating gear element 29. The wing portion 271 of the limiting element 27 may substantially align the end portion 2911 of the teeth portion 291, and the wing portion 273 of the limiting element 27 may substantially align the end portion 2913 of the teeth portion 291.

As abovementioned, the cover portion 22 is configured to match the housing portion 21. In some embodiments of the present disclosure, the cover portion 22 may include a through hole 220. The mirror head portion 14 may be connected to the actuating gear element 29 of the actuator 2 through the through hole 220.

As abovementioned, when the driving unit 23 starts operating, it may drive the driving shaft 25 to rotate. The rotation of the driving shaft 25 may cause the actuating gear element 29 to rotate. Further, the actuating gear element 29 rotates, causing the mirror head portion 14 to rotate as well. This rotation may occur around the generally vertical axis of rotation and is relative to the side 111 of the vehicle 11 where the exterior rearview mirror assembly 1 is installed. When the actuating gear element 29 rotates and comes into contact with or engage with the limiting element 27, the wing portion 271, 273 of the limiting element 27 may push against the end portion 2911, 2913 of the teeth portion 291 of the actuating gear element 29, causing the actuating gear element 29 stop rotating.

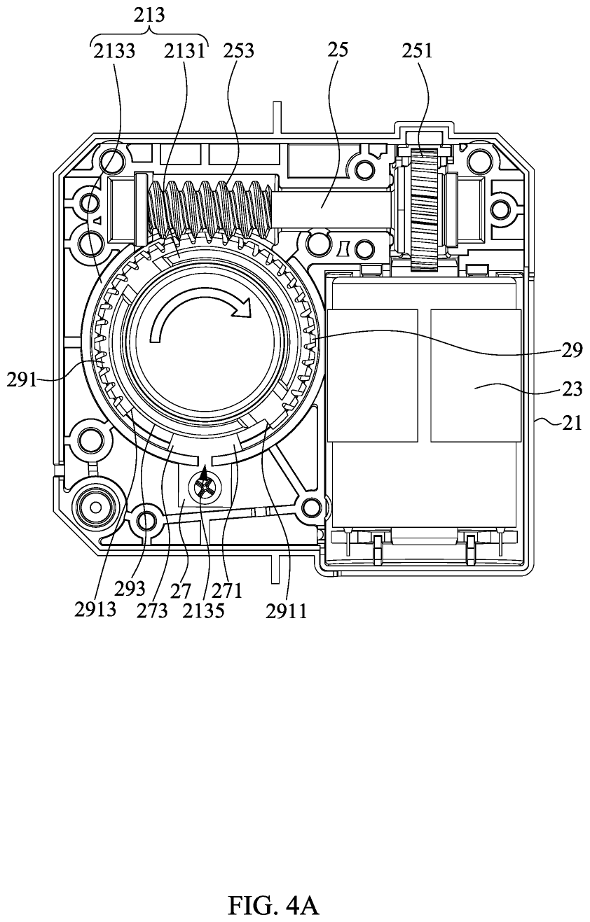

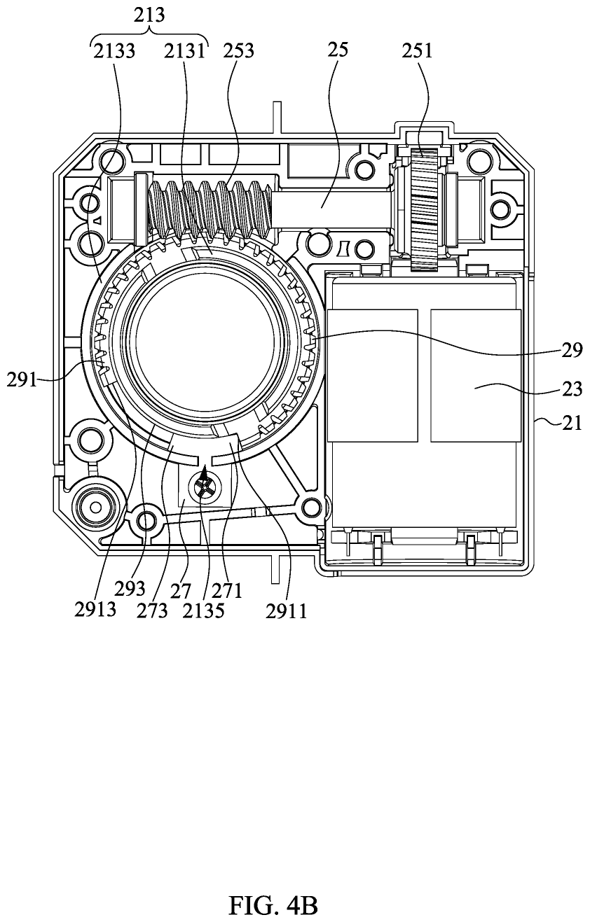

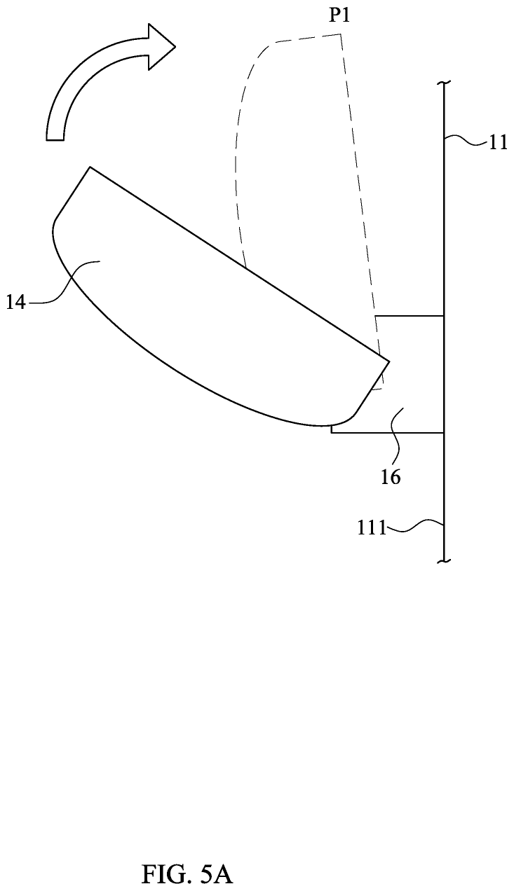

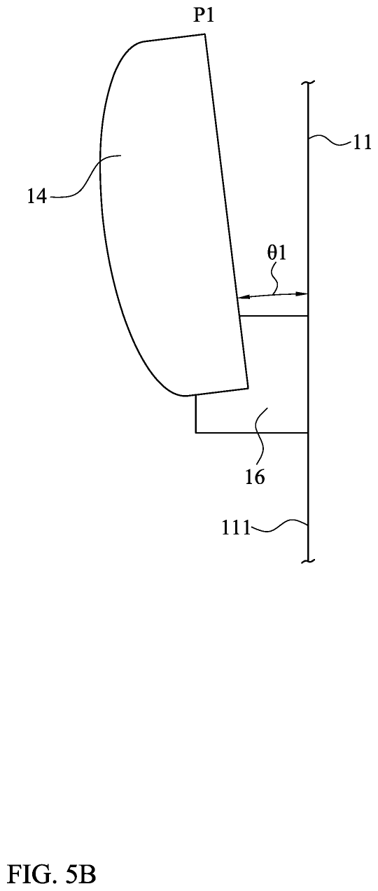

FIG. 4A shows a rotation of the actuating gear element 29. In some embodiments of the present disclosure, the driving unit 23 may drive the actuating gear element 29 to rotate in a clockwise direction (as shown in FIG. 4A). Further, the rotation of the actuating gear element 29 may impart a corresponding rotation of the mirror head portion 14 relative to the side 111 of the vehicle 11. In some embodiments of the present disclosure, the clockwise rotation of the actuating gear element 29 may gradually decrease an angle between the mirror head portion 14 and the side 111 of the vehicle 11. That is, the actuator 2 may drive the mirror head portion 14 to rotate toward a folded position P1 (referring to FIG. 5A).

Since the limiting element 27 may be fixed to the housing portion 21, there may be a relative movement between the limiting element 27 and the actuating gear element 29 when the actuating gear element 29 rotates. During the period when the actuator 2 drives the mirror head portion 14 to rotate towards the folded position P1, the limiting element 27 and the missing teeth region 293 of the actuating gear element 29 may move relative to each other, and the limiting element 27 may not block or affect the rotation of the actuating gear element 29. However, once the limiting element 27 comes into contact or engages with the actuating gear element 29, the actuating gear element will be restricted and stop rotating by the limiting element 27. As shown in FIG. 4B, the wing portion 271 of the limiting element 27 may be in contact with the end portion 2911 of the teeth portion 291 of the actuating gear element 29. When the wing portion 271 of the fixed limiting element 27 makes contact with the end portion 2911 of the teeth portion 291 of the actuating gear element 29, it may push against the end portion 2911, resulting in the cessation of rotation for the actuating gear element 29. Once the actuating gear element 29 stops rotating, the movement of the mirror head portion 14 may also come to a halt. In some embodiments of the present disclosure, the limiting element 27 is configured to engage with the actuating gear element 29 and stop its rotation when the mirror head portion is rotated to the folded position P1. That is, when the mirror head portion 14 rotates to be positioned at a predetermined minimum angle θ1 relative to the side 111 of the vehicle 11, the wing portion 271 of the limiting element 27 may contact and/or push against the end portion 2911 of the teeth portion 291 of the actuating gear element 29 so as to stop the rotation of the actuating gear element 29 (referring to FIG. 5B).

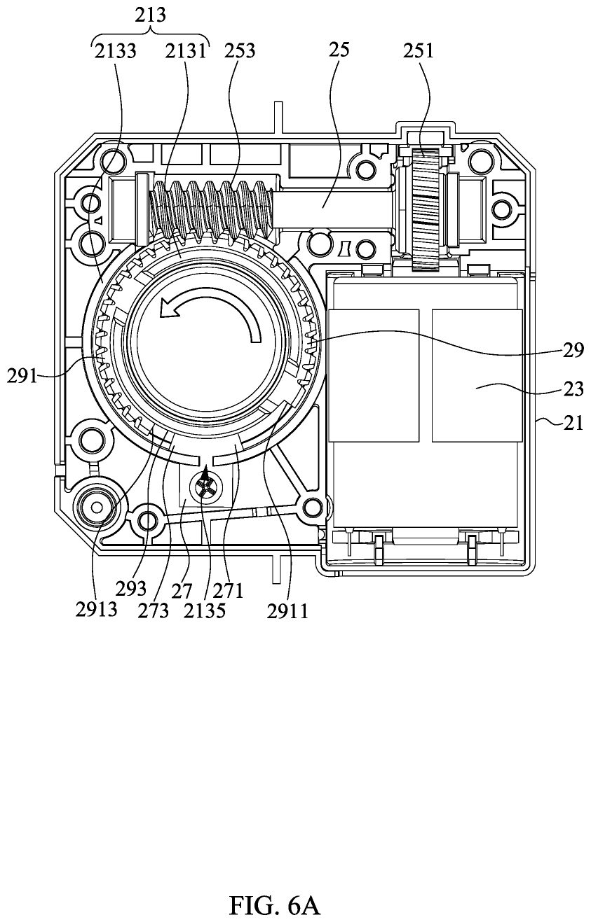

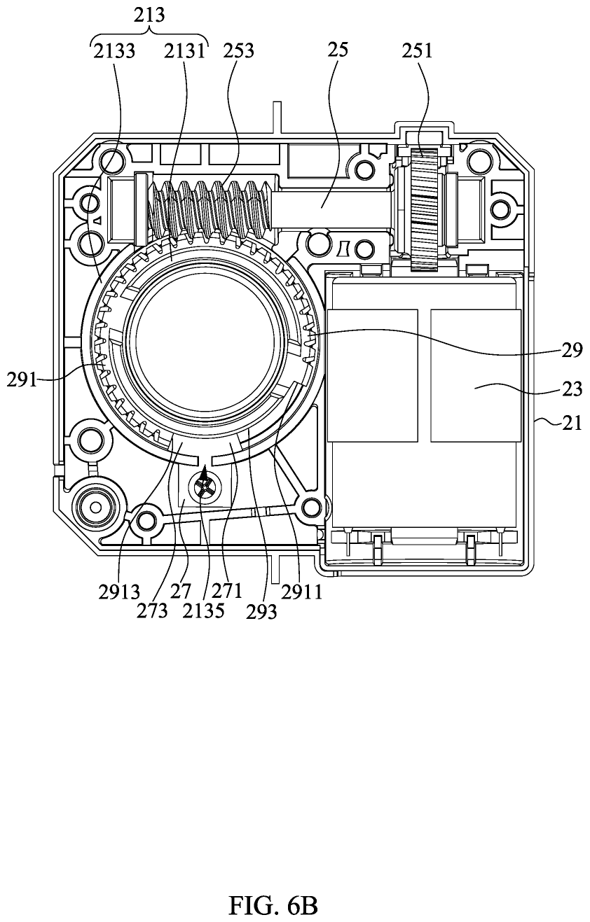

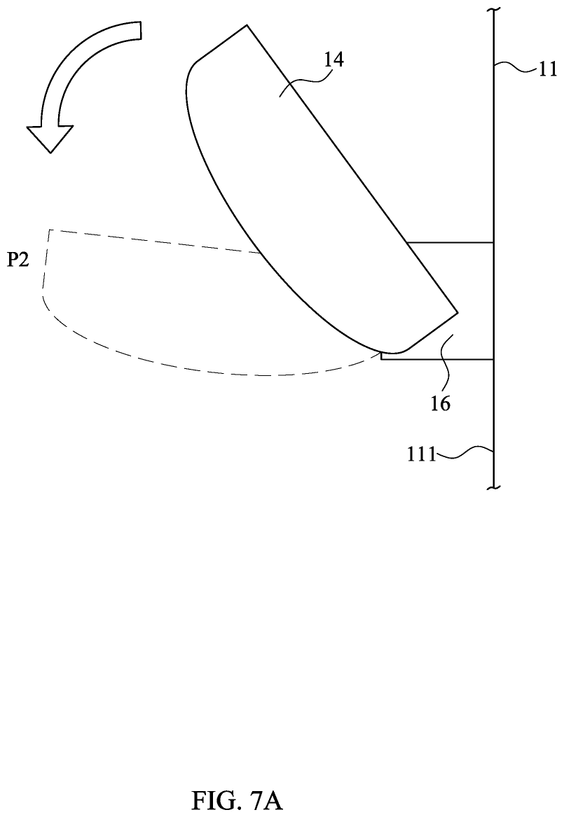

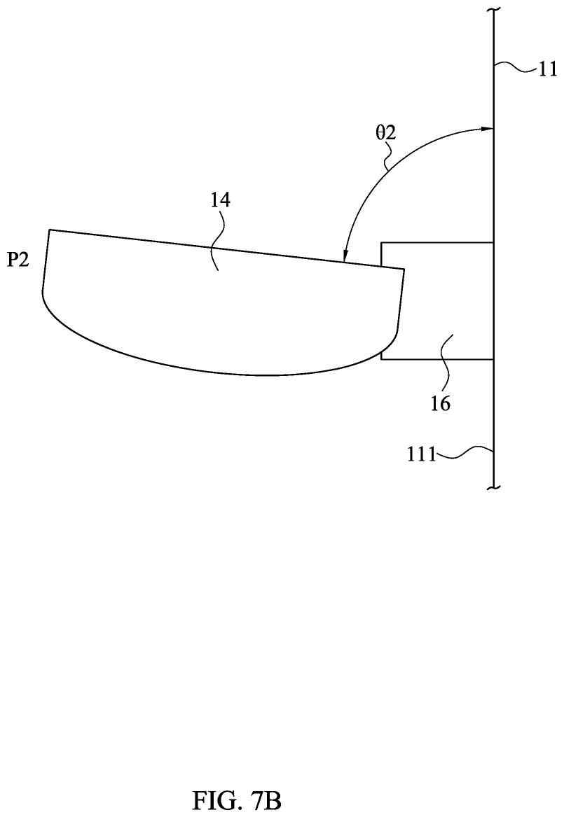

FIG. 6A shows another rotation of the actuating gear element 29. In some embodiments of the present disclosure, the driving unit 23 may drive the actuating gear element 29 to rotate in a counterclockwise direction (as shown in FIG. 6A). Further, the rotation of the actuating gear element 29 may impart a corresponding rotation of the mirror head portion 14 relative to the side 111 of the vehicle 11. In some embodiments of the present disclosure, the counterclockwise rotation of the actuating gear element 29 may gradually increase the angle between the mirror head portion 14 and the side 111 of the vehicle 11. That is, the actuator 2 may drive the mirror head portion 14 to rotate toward a use position P2 (referring to FIG. 7A).

As abovementioned, the limiting element 27 may be fixed to the housing portion 21, and thus there may be a relative movement between the limiting element 27 and the actuating gear element 29 when the actuating gear element 29 rotates. During the period when the actuator 2 drives the mirror head portion 14 to rotate towards the use position P2, the limiting element 27 and the missing teeth region 293 of the actuating gear element 29 may move relative to each other, and the limiting element 27 may not block or affect the rotation of the actuating gear element 29. However, once the limiting element 27 comes into contact or engages with the actuating gear element 29, the actuating gear element will be restricted and stop rotating by the limiting element 27. As shown in FIG. 6B, the wing portion 273 of the limiting element 27 may be in contact with the end portion 2913 of the teeth portion 291 of the actuating gear element 29. When the wing portion 273 of the fixed limiting element 27 makes contact with the end portion 2913 of the teeth portion 291 of the actuating gear element 29, it may push against the end portion 2913, resulting in the cessation of rotation for the actuating gear element 29. Once the actuating gear element 29 stops rotating, the movement of the mirror head portion 14 may also come to a halt. In some embodiments of the present disclosure, the limiting element 27 is configured to engage with the actuating gear element 29 and stop its rotation when the mirror head portion is rotated to the use position P2. That is, when the mirror head portion 14 rotates to be positioned at a predetermined maximum angle θ2 relative to the side 111 of the vehicle 11, the wing portion 273 of the limiting element 27 may contact and/or push against the end portion 2913 of the teeth portion 291 of the actuating gear element 29 so as to stop the rotation of the actuating gear element 29 (referring to FIG. 7B).

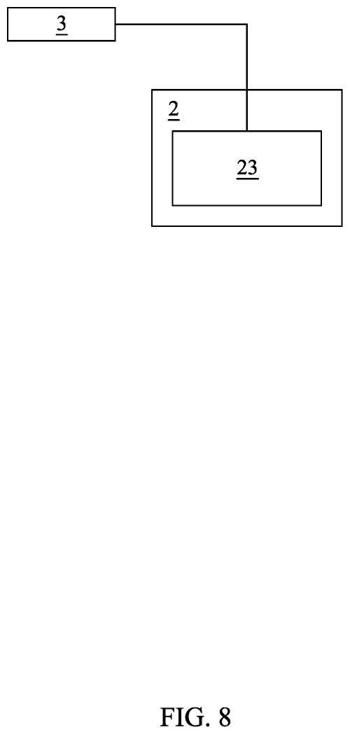

Referring to FIG. 8, the actuator 2 may be connected to a power-off circuit 3. In some embodiments of the present disclosure, the driving unit 23 of the actuator 2 may be electrically connected to the power-off circuit 3. When the limiting element 27 engages with actuating gear element 29 and causes the actuating gear element 29 to stop rotating, the rotation of the output shaft 231 of the driving unit 23 may be also restricted. However, the driving unit 23 may be still powered on at the moment, so the power to the motor must be cut off; otherwise, it will result in the driving unit 23 being burned out. The power-off circuit 3 may be connected in series with the power-off circuit 3. When the output shaft 231 of the driving unit 23 stops rotating, the current flowing through the power-off circuit 3 may increase. When the current flowing through the power-off circuit 3 exceeds a threshold value, the power will automatically be cut off to stop the driving unit 23 from working, achieving the purpose of protecting the driving unit 23.

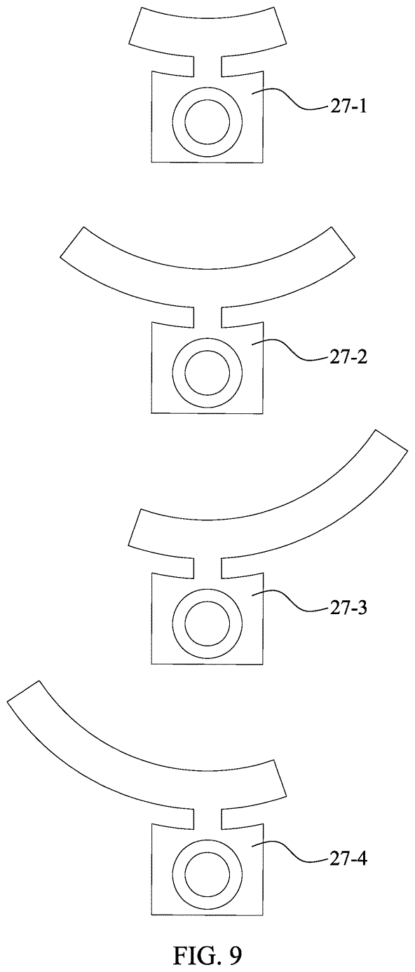

As abovementioned, when the wing portion 271, 273 of the limiting element 27 pushes against the end portion 2911, 2913 of the teeth portion 291 of the actuating gear element 29, the limiting element 27 may restrict the rotation of the actuating gear element 29. That is, a length of the wing portion 271, 273 of the limiting element 27 may be closely related to the angle at which the actuating gear element 29 rotates. In other words, the predetermined minimum angle between the mirror head portion 14 and the side 111 of the vehicle 11 (the fold position of the mirror head portion 14) and predetermined maximum angle between the mirror head portion 14 and the side 111 of the vehicle 11 (the use position of the mirror head portion 14) may be determined by the length of the wing portion 271, 273 of the limiting element 27. FIG. 9 shows various embodiments of the limiting element 27-1, 27-2, 27-3, 27-4. As shown in FIG. 9, the limiting elements 27-1, 27-2, 27-3, 27-4 may have different lengths in their wing portions. Users can choose different limiting elements 27-1, 27-2, 27-3, 27-4 according to their needs.

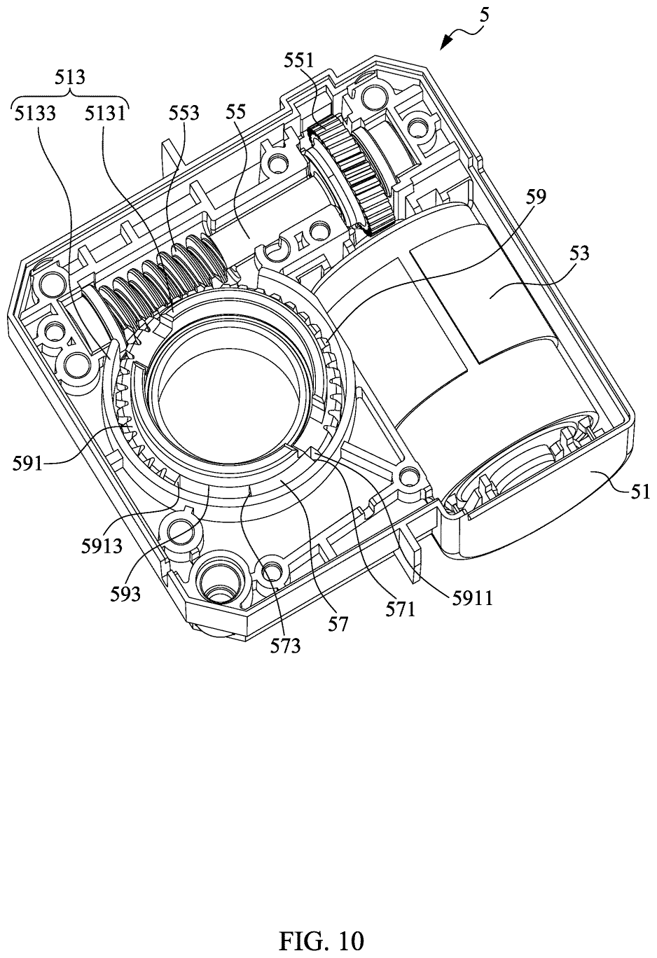

FIG. 10 shows a perspective view of an actuator 5 of an exterior rearview mirror assembly in accordance with an embodiment of the instant disclosure. The functions of the actuator 5 and the actuator 2 may be either the same or similar to each other. The actuator 5 may be used in the exterior rearview mirror assembly 1 as well. As shown in FIG. 10, the actuator 5 may include a housing portion 51, a cover portion (not shown), a driving unit 53, a driving shaft 55, a bearing assembly (not shown), a limiting element 57 and an actuating gear element 59. The housing portion 51 is configured to receive the driving unit 53. The driving unit 53 may connect the driving shaft 55 and configured to drive the driving shaft 55 to rotate. The driving shaft 55 may include a gear connected to a worm gear arranged at the output shaft of the driving unit 53. Moreover, the driving shaft 55 may include a worm gear 553 connected to the actuating gear element 59.

The actuating gear element 59 may include a teeth portion 591 and a missing teeth region 593. The teeth portion 591 may extend along a circumference of the actuating gear element 59 and include two end portions 5911 and 5913. The missing teeth region 593 may also extend along a circumference of the actuating gear element 59 and be located between the two end portions 5911 and 5913 of the teeth portion 591. The teeth of the teeth portion 591 may engage the teeth of the worm gear 553 of the driving shaft 55. Thus, when the driving unit 53 drives the driving shaft 55 to rotate, the worm gear 553 of the driving shaft 55 may cause the actuating gear element 59 to rotate accordingly.

The housing portion 51 may include an axle portion 513, and the axle portion may include an inner wall 5131 and an outer wall 5133 which substantially surrounds the inner wall 5131. The actuating gear element 59 may be received in a groove formed between the inner wall 5131 and the outer wall 5133. That is, he actuating gear element 59 may be fitted onto the axle portion 513 of the housing portion 51.

The limiting element 57 may be fixed to the housing portion 51 and adjacent to the actuating gear element 59. As shown in FIG. 10, the limiting element 57 may be disposed on an inner surface of the outer wall 5135 of the axle portion 513. In some embodiments of the present disclosure, the limiting element 57 may be integrally formed with the outer wall 5135 of the axle portion 513. Referring to FIG. 10, the limiting element 57 may be located to abut the circumference of the actuating gear element 59 and substantially align or correspond to the missing teeth region 593 of the actuating gear element 59. Further, the limiting element 57 may substantially extend along the circumference of the actuating gear element 59. The limiting element 57 may have end portions 571 and 573. The end portion 571 of the limiting element 57 may substantially align the end portion 5911 of the teeth portion 591, and the end portion 573 of the limiting element 57 may substantially align the end portion 5913 of the teeth portion 591. That is, when the actuating gear element 59 rotates and comes into contact with or engage with the limiting element 57, the end portion 571, 573 of the limiting element 57 may push against the end portion 5911, 5913 of the teeth portion 591 of the actuating gear element 59, causing the actuating gear element 59 stop rotating.

It will be appreciated that in the forgoing apparatus, the actuator for the exterior rearview mirror assembly for the vehicle provides a limiting element configured to restrict a rotation of the actuating gear element of the actuator, which may be connected to the mirror head portion. The limiting element may have a small size and be positioned to be adjacent to the actuating gear element. The structure of this limiting element can save the manufacturing cost of the actuator and significantly reduce the overall size and weight of the actuator.

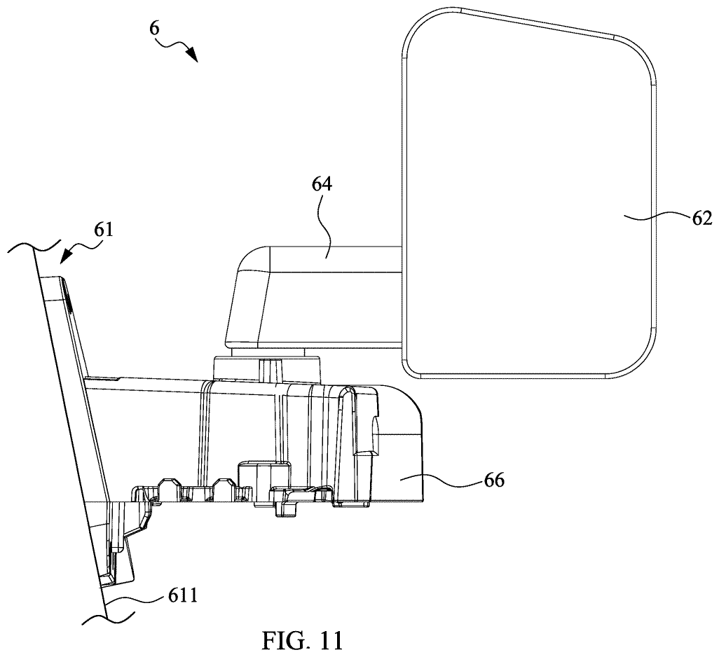

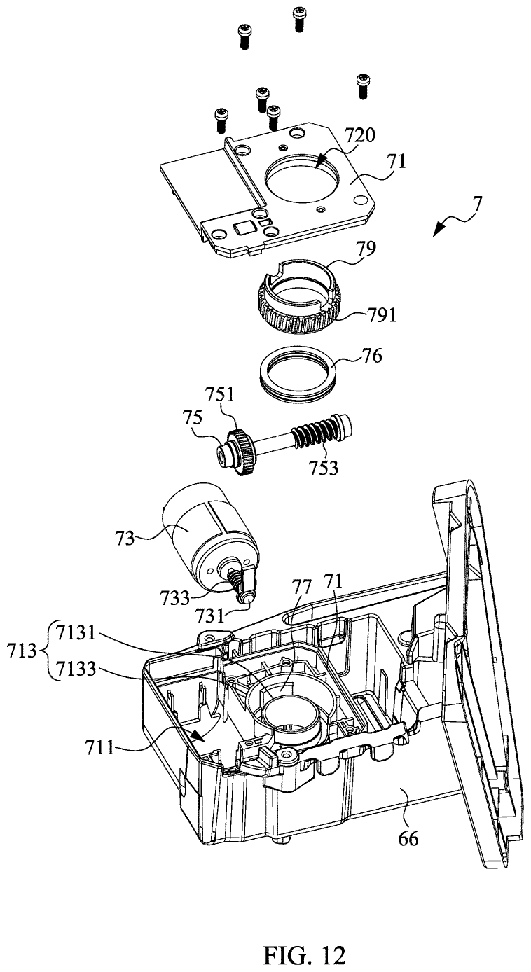

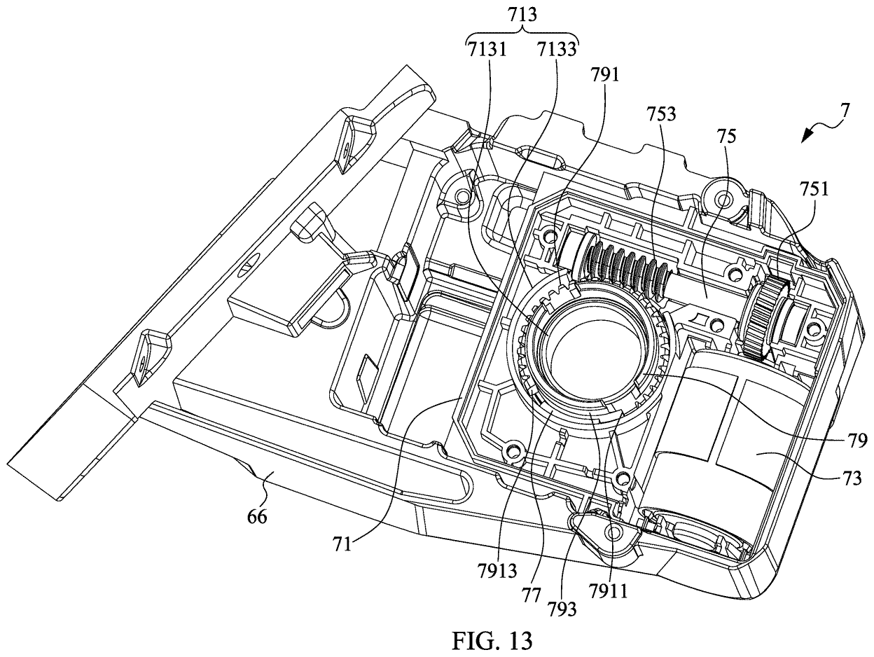

FIG. 11 is a schematic rear view of an exterior rearview mirror assembly 6 for a vehicle 61 in accordance with an embodiment of the instant disclosure. As shown in FIG. 11, the exterior rearview mirror assembly 6 for the vehicle 61 may include a mirror reflective element 62, a mirror head portion 64, a mounting portion 66, and an actuator 7 (FIGS. 12 and 13). The mirror reflective element 62 may be received in and/or supported by the mirror head portion 64. The mirror head portion 64 may be movably mounted to the mounting portion 66 via the actuator 7.

The mounting portion 66 may be mounted at a side 611 of the vehicle 61, and the mirror reflective element 62 may provide a rearward field of view along the respective side of the vehicle 61 to the driver of the vehicle 61. The actuator 7 may be received or disposed at least partially in the mounting portion 66 and is operable to pivot the mirror head portion 64 relative to the mounting portion 66 to adjust the mirror head portion 64 between a rearward viewing position or orientation, where the mirror head portion 64 and mirror reflective element 62 are positioned so as to provide a rearward field of view to the driver of the vehicle 61, and a folded or stowed position, where the mirror head portion 64 and mirror reflective element 62 are oriented generally along the side 611 of the vehicle 61.

In this embodiment, the mounting portion 66 is integrally formed with a housing portion 71 of the actuator 7 (see FIG. 12 and FIG. 13). In other words, the mounting portion 66 and the housing portion 71 may be formed as a single-piece molded structure, such that the mounting portion 66 and the housing portion 71 together constitute a unitary body without a separable joint or mating interface therebetween. The mirror head portion 64 may be pivotally or adjustably disposed at an outer side of the mounting portion 66, and the integrally formed housing portion 71 may provide a cavity or space for receiving at least a portion of the actuator 7 therein. The mirror head portion 64 may be connected to the actuator 7 directly or indirectly.

The integrally formed structure of the mounting portion 66 and the housing portion 71 may provide several advantages over a design in which the mounting portion and the housing portion are separate components that must be assembled together. First, a manufacturer may directly form the mounting portion 66 together with the housing portion 71 that functions as a base for the actuator 7 in a single molding process, thereby eliminating the need to design, manufacture, and assemble two separate components and to consider how the housing portion and the mounting portion are to be matched to satisfy the required pivot range of the mirror head portion 64. Second, because the positional relationship between a limiting element 77 disposed at the housing portion 71 and the mounting portion 66 is established during the molding process, the positional accuracy of the limiting element 77 relative to the mounting surface of the mounting portion 66 is determined by mold precision rather than by assembly tolerance, thereby providing a more reliable and consistent predetermined angular position of the mirror head portion 64 relative to the side 611 of the vehicle 61. Third, the integrally formed structure eliminates the mating interface between the mounting portion and the housing portion, thereby reducing mechanical play or loosening during vehicle operation and improving the overall structural rigidity of the exterior rearview mirror assembly 6. Fourth, the elimination of the mating interface may also improve the sealing performance of the exterior rearview mirror assembly 6 against ingress of water or dust. Fifth, the number of parts required to manufacture the exterior rearview mirror assembly 6 may be reduced, and the assembly process may be simplified, thereby improving manufacturing yield and lowering production cost. Sixth, the integrally formed structure provides design flexibility in that, for different vehicle models requiring different pivot angles of the mirror head portion 64, only the relevant features of a single mold need to be modified, rather than redesigning two separate components and their mating structure.

In some embodiments of the present disclosure, the mirror reflective element 62 may be attached to a mounting surface of or at the mirror head portion 64. In some embodiments of the present disclosure, the mirror reflective element 62 may be received in or partially received in a receiving structure or bezel structure at the mirror head portion 64 (and may be attached at a mounting plate or backing plate that may be adjustably mounted or disposed in the mirror casing and that may be adjustable via a powered mirror reflective element adjustment actuator to allow for adjustment of the mirror reflective element 62 relative to the mirror casing to establish a desired rearward field of view to the driver of the vehicle), while remaining within the spirit and scope of the present invention. The mirror reflective element 62 may be adjustably mounted or supported at or in or partially in the mirror head portion 64, such as via a reflective element actuator or the like.

FIG. 12 is an exploded perspective view of the actuator 7 of the exterior rearview mirror assembly 6 in accordance with an embodiment of the instant disclosure. FIG. 13 is a top plan view of the actuator 7 of the exterior rearview mirror assembly 6 in accordance with an embodiment of the instant disclosure. The actuator 7 may be operable to pivot or adjust the mirror head portion 64 relative to the mounting portion 66 such that the mirror head portion 64 may be adjusted relative to the mounting portion 66 about a generally vertical pivot axis. As shown in FIGS. 12 and 13, the actuator 7 may include the housing portion 71, a cover portion 72, a driving unit 73, a driving shaft 75, a bearing assembly 76, a limiting element 77, and an actuating gear element 79. As described above, the housing portion 71 is integrally formed with the mounting portion 66, such that the housing portion 71 and the mounting portion 66 constitute a unitary structure serving as a base of the actuator 7. The cover portion 72 may be configured to match the housing portion 71, and the housing portion 71 and the cover portion 72 may together form an outer casing of the actuator 7. The outer casing formed by the housing portion 71 and the cover portion 72 may be configured to house or support the driving unit 73, the driving shaft 75, the bearing assembly 76, the limiting element 77, and the actuating gear element 79. In some embodiments of the present disclosure, the housing portion 71 and the cover portion 72 may be configured or molded to provide an inner cavity for receiving the driving unit 73, the driving shaft 75, the bearing assembly 76, the limiting element 77, and the actuating gear element 79.

Referring to FIGS. 12 and 13, the housing portion 71 may include an inner space 711 for receiving the driving unit 73. In some embodiments of the present disclosure, the driving unit 73 may include a rotary motor. In some embodiments of the present disclosure, the driving unit 73 may consist of electrically powered motors, which can be connected to the vehicle's power source. This connection can be achieved through electrical leads of the motor that are connected to the vehicle wiring harness located at the side of the vehicle 61 and at the mounting portion 66.

The driving unit 73 may include a rotationally driven output shaft 731 with a worm gear 733 attached to the output shaft 731. The driving shaft 75 may include a gear 751 and a worm gear 753. The gear 751 may be disposed to be adjacent to one end of the driving shaft 75 and the worm gear 753 may be disposed to be adjacent to an opposite end of the driving shaft 75. The teeth of the worm gear 733 of the driving unit 73 may engage the teeth of the gear 751 of the driving shaft 75. Once the driving unit 73 drives the worm gear 733 to rotate, it will cause the driving shaft 75 with the gear 751 meshing with the worm gear 733 to rotate. Further, the worm gear 753 attached to the opposite end of the driving shaft 75 may rotate accordingly.

Referring to FIG. 12 and FIG. 13, the housing portion 71 may include an axle portion 713, and the axle portion 713 may include an inner wall 7131 and an outer wall 7133 which substantially surrounds the inner wall 7131. As shown in FIG. 12 and FIG. 13, the inner wall 7131 and the outer wall 7133 are spaced apart from each other, and thus a groove is formed between the inner wall 7131 and the outer wall 7133. The bearing assembly 76 and the actuating gear element 79 may be received in the groove formed between the inner wall 7131 and the outer wall 7133. That is, the actuating gear element 79 may be fitted onto the axle portion 713 of the housing portion 71 and rotatably supported (such as via the bearing assembly 76) at the housing portion 71. In some embodiments of the present disclosure, the axle portion 713 may also be integrally formed with the housing portion 71 and the mounting portion 66 as part of the single-piece molded structure, such that the mounting portion 66, the housing portion 71, and the axle portion 713 constitute a unitary body in which the spatial relationship among these elements is determined by the molding process.

In some embodiments of the present disclosure, the actuating gear element 79 may include a ring-shaped gear. In some embodiments of the present disclosure, the actuating gear element 79 is similar to or the same as the actuating gear 29 as shown in FIG. 2. That is, the actuating gear 29 may also include a partly tooth missing gear. In some embodiments of the present disclosure, the actuating gear element 79 may include a worm wheel. In some embodiments of the present disclosure, the actuating gear element 79 may include a partly tooth missing gear. As shown in FIG. 13, the actuating gear element 79 may include a teeth portion 791 and a missing teeth region 793. The teeth portion 791 may extend along a circumference of the actuating gear element 79 and include a first end portion 7911 and a second end portion 7913. The missing teeth region 793 may also extend along the circumference of the actuating gear element 79 and be located between the first end portion 7911 and the second end portion 7913 of the teeth portion 791. Further, the teeth of the teeth portion 791 may engage the teeth of the worm gear 753 of the driving shaft 75. Thus, when the driving unit 73 drives the driving shaft 75 to rotate, the worm gear 753 of the driving shaft 75 may cause the actuating gear element 79 to rotate accordingly.

Moreover, the actuating gear element 79 may include an attaching portion 795 with a slot 7950. In some embodiments of the present disclosure, the mirror head portion 64 may be connected to the actuating gear element 79 through the attaching portion 795 and/or the slot 7950 of the attaching portion 795. In some embodiments of the present disclosure, the mirror head portion 64 may be connected to the actuating gear element 79 via an attaching means, and the attaching means may be fixedly attached at the attaching portion 795 and/or the slot 7950 of the attaching portion 795. That is, the rotation of the actuating gear element 79 may impart a corresponding rotation of the mirror head portion 64 about the generally vertical axis of rotation and relative to the side 611 of the vehicle 61 equipped with the exterior rearview mirror assembly 6.

Referring to FIGS. 12 and 13, the limiting element 77 may be disposed at the housing portion 71 and adjacent to the actuating gear element 79. The limiting element 77 may be disposed at the outer wall 7133 of the axle portion 713. In some embodiments of the present disclosure, the limiting element 77 may be integrally formed with the outer wall 7133 of the axle portion 713. In such embodiments, the mounting portion 66, the housing portion 71, the axle portion 713, and the limiting element 77 may together constitute a single-piece molded structure. Because the limiting element 77 is integrally formed with the outer wall 7133 of the axle portion 713, which in turn is integrally formed with the housing portion 71 and the mounting portion 66, the position of the limiting element 77 relative to the mounting surface of the mounting portion 66 is fixed by the single-piece molded structure and is therefore determined during the molding process rather than during a subsequent assembly process. This integrally formed configuration eliminates the need for post-assembly alignment of the limiting element 77, and the predetermined angular position at which the limiting element 77 restricts the pivotal movement of the mirror head portion 64 is established with high positional accuracy.

As shown in FIG. 13, the limiting element 77 may be located to abut the circumference of the actuating gear element 79 and substantially align or correspond to the missing teeth region 793 of the actuating gear element 79. The limiting element 77 may comprise a first contact surface and a second contact surface, wherein the first contact surface may substantially align with the first end portion 7911 of the teeth portion 791, and the second contact surface may substantially align with the second end portion 7913 of the teeth portion 791. Accordingly, the first contact surface of the limiting element 77 may be configured to abut the first end portion 7911 of the teeth portion 791 when the mirror head portion 64 pivots to a predetermined minimum angle relative to the side 611 of the vehicle 61, and the second contact surface of the limiting element 77 may be configured to abut the second end portion 7913 of the teeth portion 791 when the mirror head portion 64 pivots to a predetermined maximum angle relative to the side 611 of the vehicle 61.

As abovementioned, the cover portion 72 is configured to match the housing portion 71. In some embodiments of the present disclosure, the cover portion 72 may include a through hole 720. The mirror head portion 64 may be connected to the actuating gear element 79 of the actuator 7 through the through hole 720.

As abovementioned, when the driving unit 73 starts operating, it may drive the driving shaft 75 to rotate. The rotation of the driving shaft 75 may cause the actuating gear element 79 to rotate. Further, the actuating gear element 79 rotates, causing the mirror head portion 64 to rotate as well. This rotation may occur around the generally vertical axis of rotation and is relative to the side 611 of the vehicle 61 where the exterior rearview mirror assembly 6 is installed. When the actuating gear element 79 rotates and comes into contact with or engages with the limiting element 77, the first contact surface or the second contact surface of the limiting element 77 may push against the first end portion 7911 or the second end portion 7913 of the teeth portion 791 of the actuating gear element 79, causing the actuating gear element 79 to stop rotating.

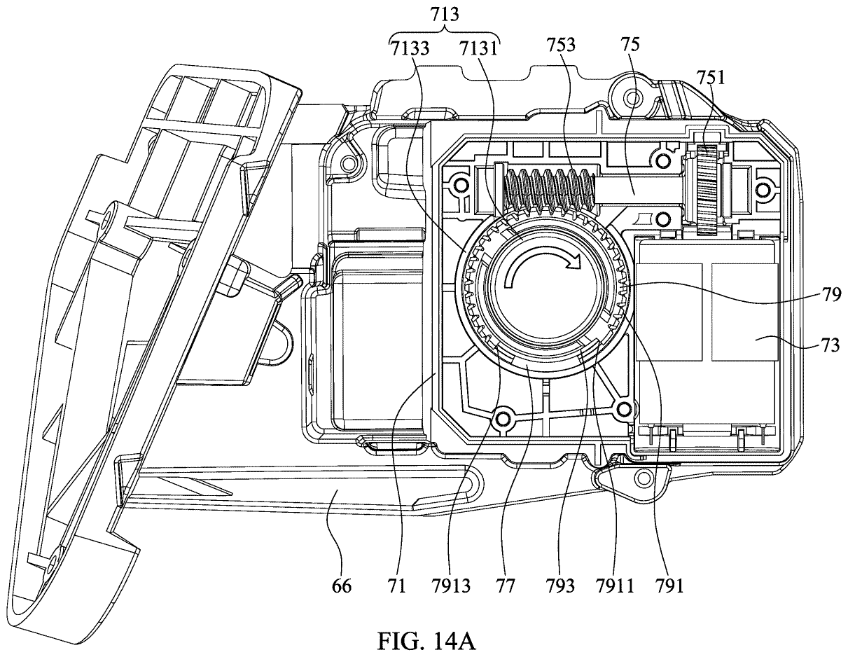

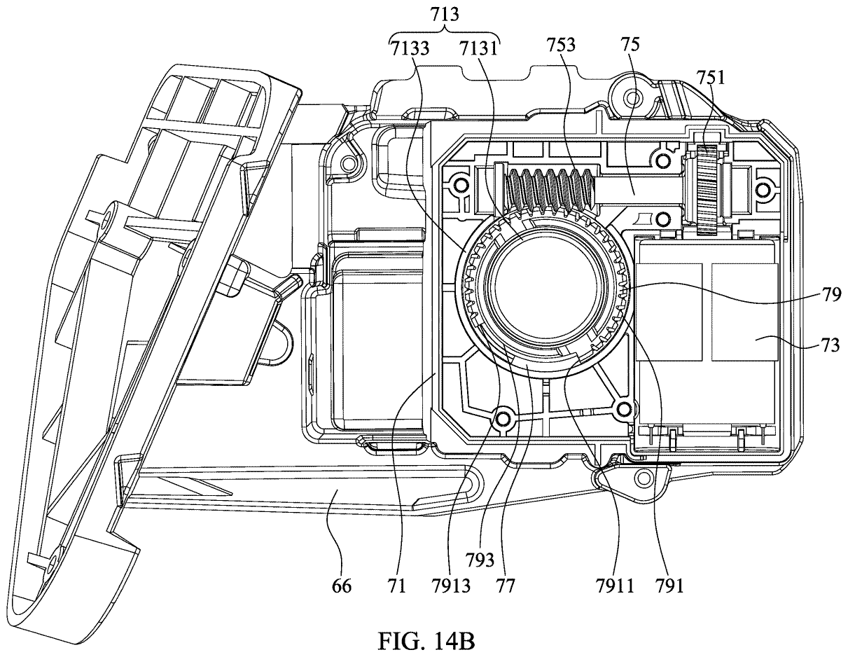

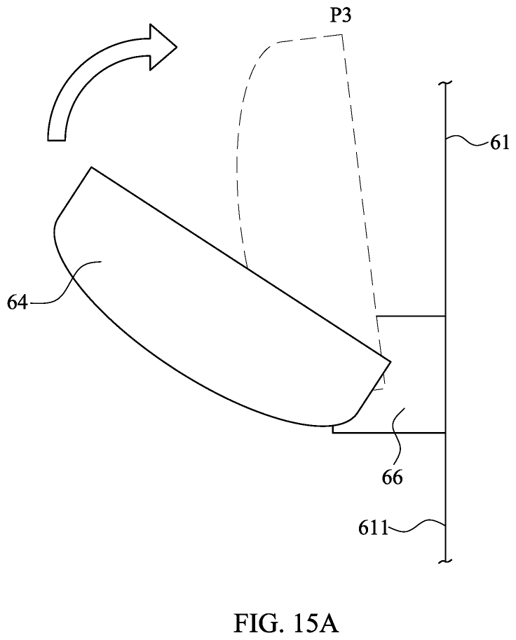

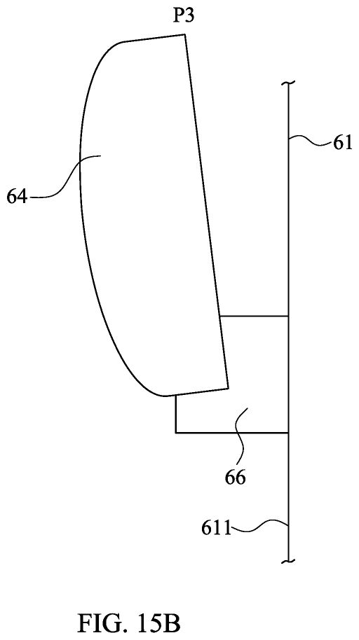

FIG. 14A shows a rotation of the actuating gear element 79. In some embodiments of the present disclosure, the driving unit 73 may drive the actuating gear element 79 to rotate in a clockwise direction (as shown in FIG. 14A). Further, the rotation of the actuating gear element 79 may impart a corresponding rotation of the mirror head portion 64 relative to the side 611 of the vehicle 61. In some embodiments of the present disclosure, the clockwise rotation of the actuating gear element 79 may gradually decrease an angle between the mirror head portion 64 and the side 611 of the vehicle 61. That is, the actuator 7 may drive the mirror head portion 64 to rotate toward a folded position P3 (referring to FIG. 15A).

Since the limiting element 77 is disposed at the housing portion 71, which is integrally formed with the mounting portion 66, there may be a relative movement between the limiting element 77 and the actuating gear element 79 when the actuating gear element 79 rotates. During the period when the actuator 7 drives the mirror head portion 64 to rotate towards the folded position, the limiting element 77 and the missing teeth region 793 of the actuating gear element 79 may move relative to each other, and the limiting element 77 may not block or affect the rotation of the actuating gear element 79. However, once the limiting element 77 comes into contact or engages with the actuating gear element 79, the actuating gear element 79 will be restricted and stop rotating by the limiting element 77. As shown in FIG. 14B, the first contact surface of the limiting element 77 may be in contact with the first end portion 7911 of the teeth portion 791 of the actuating gear element 79. When the first contact surface of the limiting element 77 makes contact with the first end portion 7911 of the teeth portion 791 of the actuating gear element 79, it may push against the first end portion 7911, resulting in the cessation of rotation for the actuating gear element 79. Once the actuating gear element 79 stops rotating, the movement of the mirror head portion 64 may also come to a halt. In some embodiments of the present disclosure, the limiting element 77 is configured to engage with the actuating gear element 79 and stop its rotation when the mirror head portion 64 is rotated to the folded position. That is, when the mirror head portion 64 rotates to be positioned at a predetermined minimum angle relative to the side 611 of the vehicle 61, the first contact surface of the limiting element 77 may contact and/or push against the first end portion 7911 of the teeth portion 791 of the actuating gear element 79 so as to stop the rotation of the actuating gear element 79 (referring to FIG. 15B). Because the limiting element 77 and the mounting portion 66 form part of the same single-piece molded structure, the predetermined minimum angle is consistently maintained from unit to unit without variations arising from assembly tolerances.

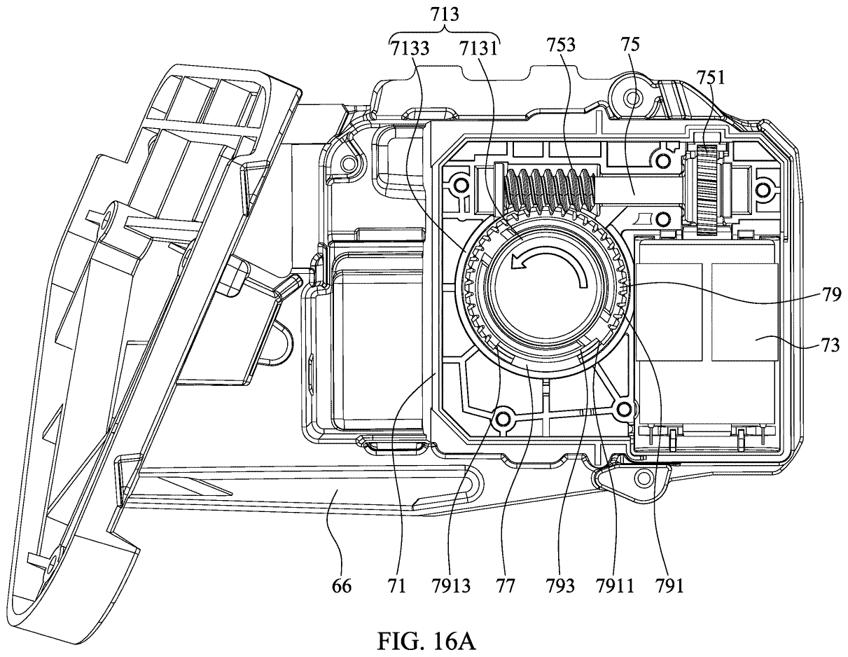

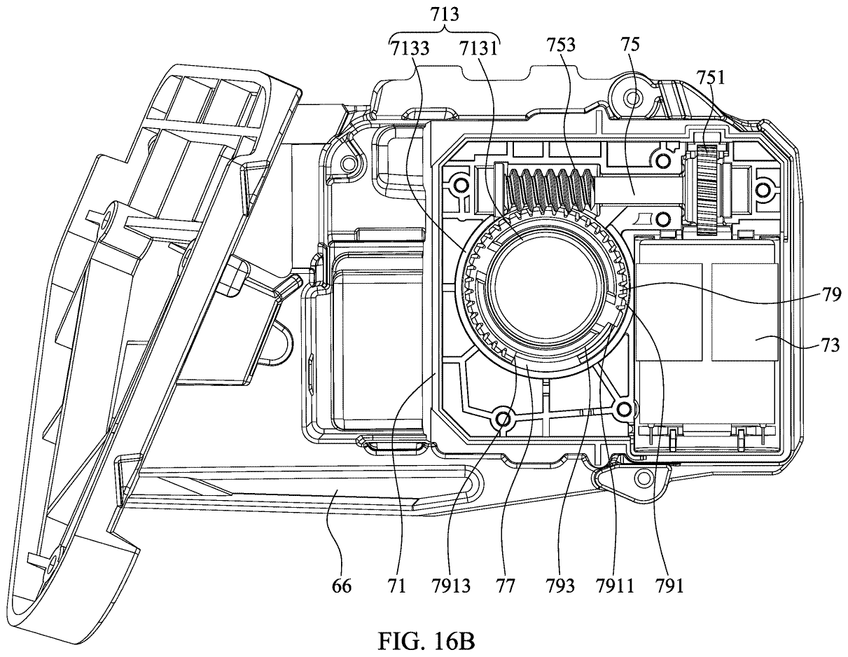

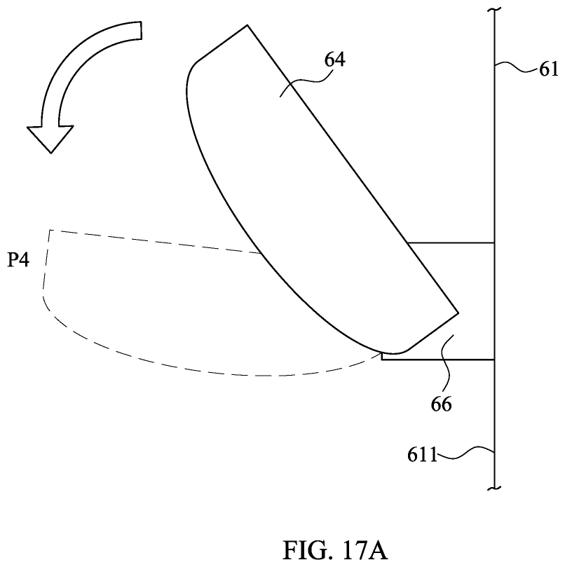

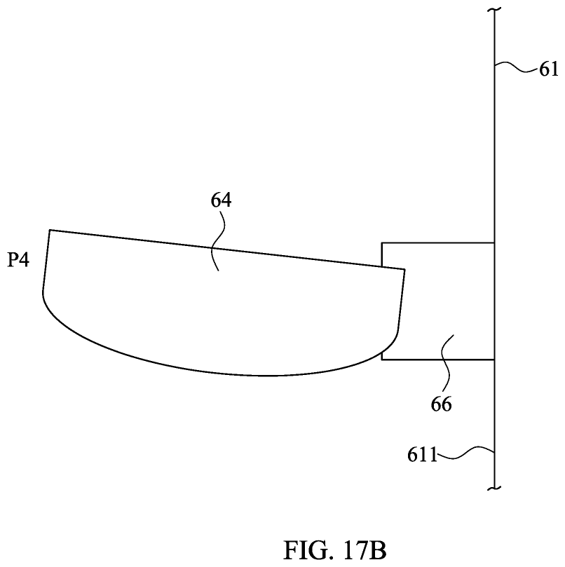

FIG. 16A shows another rotation of the actuating gear element 79. In some embodiments of the present disclosure, the driving unit 73 may drive the actuating gear element 79 to rotate in a counterclockwise direction (as shown in FIG. 16A). Further, the rotation of the actuating gear element 79 may impart a corresponding rotation of the mirror head portion 64 relative to the side 611 of the vehicle 61. In some embodiments of the present disclosure, the counterclockwise rotation of the actuating gear element 79 may gradually increase the angle between the mirror head portion 64 and the side 611 of the vehicle 61. That is, the actuator 7 may drive the mirror head portion 64 to rotate toward a use position P4 (referring to FIG. 17A).

As abovementioned, the limiting element 77 is disposed at the housing portion 71 that is integrally formed with the mounting portion 66, and thus there may be a relative movement between the limiting element 77 and the actuating gear element 79 when the actuating gear element 79 rotates. During the period when the actuator 7 drives the mirror head portion 64 to rotate towards the use position, the limiting element 77 and the missing teeth region 793 of the actuating gear element 79 may move relative to each other, and the limiting element 77 may not block or affect the rotation of the actuating gear element 79. However, once the limiting element 77 comes into contact or engages with the actuating gear element 79, the actuating gear element 79 will be restricted and stop rotating by the limiting element 77. As shown in FIG. 16B, the second contact surface of the limiting element 77 may be in contact with the second end portion 7913 of the teeth portion 791 of the actuating gear element 79. When the second contact surface of the limiting element 77 makes contact with the second end portion 7913 of the teeth portion 791 of the actuating gear element 79, it may push against the second end portion 7913, resulting in the cessation of rotation for the actuating gear element 79. Once the actuating gear element 79 stops rotating, the movement of the mirror head portion 64 may also come to a halt. In some embodiments of the present disclosure, the limiting element 77 is configured to engage with the actuating gear element 79 and stop its rotation when the mirror head portion 64 is rotated to the use position. That is, when the mirror head portion 64 rotates to be positioned at a predetermined maximum angle relative to the side 611 of the vehicle 61, the second contact surface of the limiting element 77 may contact and/or push against the second end portion 7913 of the teeth portion 791 of the actuating gear element 79 so as to stop the rotation of the actuating gear element 79 (referring to FIG. 17B). Similarly, because the limiting element 77 forms part of the single-piece molded structure together with the mounting portion 66, the predetermined maximum angle is consistently maintained across manufactured units.

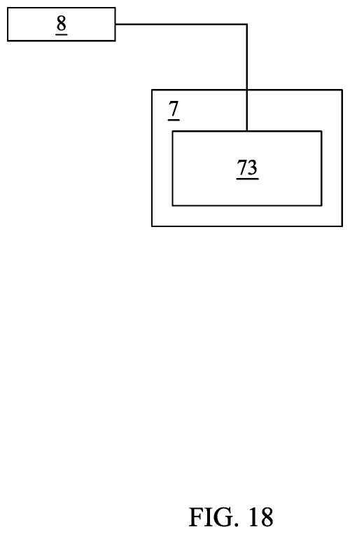

Referring to FIG. 18, the actuator 7 may be connected to a power-off circuit 8. In some embodiments of the present disclosure, the driving unit 73 of the actuator 7 may be electrically connected to the power-off circuit 8. When the limiting element 77 engages with the actuating gear element 79 and causes the actuating gear element 79 to stop rotating, the rotation of the output shaft 731 of the driving unit 73 may be also restricted. However, the driving unit 73 may be still powered on at the moment, so the power to the motor must be cut off; otherwise, it will result in the driving unit 73 being burned out. The power-off circuit 8 may be connected in series with the driving unit 73. When the output shaft 731 of the driving unit 73 stops rotating, the current flowing through the power-off circuit 8 may increase. When the current flowing through the power-off circuit 8 exceeds a threshold value, the power will automatically be cut off to stop the driving unit 73 from working, achieving the purpose of protecting the driving unit 73.

It will be appreciated that in the exterior rearview mirror assembly 6 and the actuator 7 described above, the mounting portion 66 is integrally formed with the housing portion 71 to constitute a single-piece molded structure. The integrally formed structure establishes a fixed positional relationship between the limiting element 77 and the mounting portion 66, such that the predetermined angular position of the actuating gear element 79 corresponds to a predetermined pivot angle of the mirror head portion 64 relative to the side 611 of the vehicle 61 with high precision. This integrally formed configuration eliminates the mating interface between the mounting portion and the housing portion of conventional two-piece designs, thereby improving structural rigidity, reducing part count, simplifying the assembly process, improving manufacturing yield, enhancing sealing performance, and providing design flexibility for different vehicle models with different pivot range requirements. Moreover, when the limiting element 77 is integrally formed with the outer wall 7133 of the axle portion 713 as part of the single-piece molded structure, the positional accuracy of the limiting element 77 relative to the mounting surface of the mounting portion 66 is determined by mold precision, thereby ensuring consistent pivot angles of the mirror head portion 64 across manufactured units without reliance on post-assembly alignment.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An exterior rearview mirror assembly for a vehicle, comprising:
a mounting portion mountable at a side of the vehicle, the mounting portion having a housing portion integrally formed therewith;
a mirror head portion adjustably mounted at the mounting portion;
a reflective element at the mirror head portion; and
an actuator at least partially received in the housing portion and operable to impart pivotal movement of the mirror head portion relative to the mounting portion;
wherein the actuator comprises:
a gear element rotatably supported within the housing portion,
a driving unit configured to drive the gear element, and
a limiting element disposed at the housing portion and configured to engage the gear element to restrict the pivotal movement of the mirror head portion at a predetermined angular position relative to the side of the vehicle.

2. The exterior rearview mirror assembly of claim 1, wherein the mounting portion and the housing portion are formed as a single-piece molded structure.

3. The exterior rearview mirror assembly of claim 1, wherein the housing portion comprises an axle portion having an inner wall and an outer wall surrounding the inner wall, with a groove defined between the inner wall and the outer wall, and wherein the gear element is rotatably received in the groove.

4. The exterior rearview mirror assembly of claim 3, wherein the limiting element is disposed at the outer wall of the axle portion.

5. The exterior rearview mirror assembly of claim 4, wherein the limiting element is integrally formed with the outer wall of the axle portion.

6. The exterior rearview mirror assembly of claim 5, wherein the mounting portion, the housing portion, the axle portion, and the limiting element together constitute a single-piece molded structure.

7. The exterior rearview mirror assembly of claim 4, wherein the outer wall of the axle portion defines a recess, and the limiting element is received in the recess.

8. The exterior rearview mirror assembly of claim 1, wherein the gear element has a teeth portion and a missing teeth region, wherein the teeth portion extends along a circumference of the gear element and has a first end and a second end, wherein the missing teeth region extends along the circumference between the first end and the second end, and wherein the limiting element is positioned to correspond to the missing teeth region.

9. The exterior rearview mirror assembly of claim 8, wherein the limiting element comprises a first contact surface and a second contact surface, wherein the first contact surface is configured to abut the first end of the teeth portion when the mirror head portion pivots to a predetermined minimum angle relative to the side of the vehicle, and wherein the second contact surface is configured to abut the second end of the teeth portion when the mirror head portion pivots to a predetermined maximum angle relative to the side of the vehicle.

10. The exterior rearview mirror assembly of claim 1, further comprising a power-off circuit electrically connected to the driving unit, wherein when the limiting element engages the gear element and the gear element ceases to rotate, the power-off circuit is configured to interrupt power to the driving unit in response to a current flowing through the power-off circuit exceeding a threshold value.

11. An actuator assembly for an exterior rearview mirror assembly for a vehicle, comprising:
a mounting base integrally formed with a housing portion, the mounting base being mountable at a side of the vehicle and the housing portion defining an inner cavity configured to receive an actuating mechanism;
a gear element rotatably supported by the housing portion and operably connectable to a mirror head portion of the exterior rearview mirror assembly;
a driving unit received in the housing portion and configured to drive the gear element to rotate; and
a limiting element disposed at the housing portion and configured to engage the gear element to restrict rotation of the gear element at a predetermined angular position,
wherein the integrally formed mounting base and housing portion establish a fixed positional relationship between the limiting element and the mounting base, such that the predetermined angular position of the gear element corresponds to a predetermined pivot angle of the mirror head portion relative to the side of the vehicle.

12. The actuator assembly of claim 11, wherein the mounting base and the housing portion are formed as a single-piece molded structure, and wherein the single-piece molded structure defines a fixed spatial relationship between a mounting surface of the mounting base and the limiting element.

13. The actuator assembly of claim 11, wherein the housing portion comprises an axle portion having an inner wall and an outer wall surrounding the inner wall, with a groove defined between the inner wall and the outer wall, and wherein the gear element is rotatably received in the groove.

14. The actuator assembly of claim 13, wherein the limiting element is disposed at the outer wall of the axle portion.

15. The actuator assembly of claim 14, wherein the limiting element is integrally formed with the outer wall of the axle portion.

16. The actuator assembly of claim 15, wherein the mounting base, the housing portion, the axle portion, and the limiting element together constitute a single-piece molded structure.

17. The actuator assembly of claim 14, wherein the outer wall of the axle portion defines a recess, and the limiting element is received in the recess.

18. The actuator assembly of claim 11, wherein the gear element has a teeth portion and a missing teeth region, wherein the teeth portion has a first end and a second end and extends along a circumference of the gear element, wherein the missing teeth region is located along the circumference between the first end and the second end, and wherein the limiting element is positioned to correspond to the missing teeth region.

19. The actuator assembly of claim 18, wherein the limiting element comprises a first contact surface and a second contact surface, wherein the first contact surface is configured to abut the first end of the teeth portion when the gear element rotates in a first direction by a first angle corresponding to a folded position of the mirror head portion relative to the side of the vehicle, and wherein the second contact surface is configured to abut the second end of the teeth portion when the gear element rotates in a second direction by a second angle corresponding to a use position of the mirror head portion relative to the side of the vehicle.

20. The actuator assembly of claim 11, further comprising a power-off circuit electrically connected to the driving unit, wherein when the limiting element engages the gear element and rotation of the gear element is restricted, the power-off circuit is configured to interrupt power supplied to the driving unit when a current flowing through the power-off circuit exceeds a threshold value.
